(19) United States
(12) Patent Application Publication
(10) Pub. No.: US 2022/0058017 A1
(43) Pub. Date: Feb. 24, 2022

(54) MAPPING FOR SOFTWARE COMPLIANCE

(71) Applicant: LUXEMBOURG INSTITUTE OF SCIENCE AND TECHNOLOGY(LIST), Esch-sur-Alzette (LU)

(72) Inventor: Jean-Sébastien SOTTET, Metz (FR)

(21) Appl. No.: 17/415,250

(22) PCT Filed: Dec. 17, 2019
(86) PCT No.: PCT/EP19/85530

§ 371 Date: Jun. 17, 2021

(30) Foreign Application Priority Data
Dec. 21, 2018 (EP) 18215597.8
Jul. 24, 2019 (LU) LU101324

(51) Int. Cl. G06F 8/75; G06F 8/41

(52) U.S. Cl. CPC G06F 8/751; G06F 8/42; G06F 8/436

(57) ABSTRACT

A method for the identification of similarities and dissimilarities of mappings between the elements of a first model and the elements of a second model, an element being one of: an object, a link, a node, a class, an attribute, an activity, a flow, etc., wherein the method uses a processor for performing a model mining of the elements of both models in accordance with pre-defined rules and through at least two of the following analyses: a semantic analysis of the elements; a syntactic and/or structural analysis of the elements; a data-based analysis of the elements; and wherein based on these analyses and potentially also based on pre-performed mappings, similarities and dissimilarities mappings between the elements of the first model and the second model are identified and are provided to a user.

The present invention is the US national stage under 35 U.S.C. § 371 of International Application No. PCT/EP2019/085530 which was filed on Dec. 17, 2019, and which claims the priority of application EP 18215597.8 filed Dec. 21, 2018, and application LU 101324 filed on Dec. Jul. 24, 2019, the content of which (text, drawings and claims) are incorporated here by reference in its entirety.

### FIELD

The invention is directed to the mapping of a first model to a second model to identify potential similarities or dissimilarities between the two models and in particular to identify dissimilarities between a software model and a legal model.

### BACKGROUND

In the context of Information Technology, Information Processing, and the use of computers and software, there are many descriptions or models that can be automatically processed by computers, such as software models (including models of code written in most of programming languages or computer machine languages), knowledge representation models, data models, workflow models, UML models, BPMN models, ArchiMate models, Business Rules models, Decision tree Rules models, StateChart rules models, ontology-based models, flowcharts, IDEF models, XPDL models, Petri nets models, etc. Those models can be represented textually or graphically. Most of them are formally defined, and annotated graphs (from graph theory) can be used for this formal representation that can be stored in and automatically processed by, computers. This can be done, for instance, in a graph representation such as GraphML (even if the data is actually stored in any kind of database).

Thus, many models may be used to produce an IT application, each of them describing differently, at different levels of abstraction or details, different parts of the application. The various models are interrelated. For instance, in UML modelling, a class model is related to the objects defined in JAVA code, but the class model can also be related to some OWL ontology representing a part of a regulatory text (e.g. the General Data Protection Regulation GDPR in EU). In order to prevent or remove defects in those models—which often result in defects at runtime of the software applications based on those models—it is helpful to detect and materialize links between those related models.

Another example may be a legal domain having hierarchically organized concepts and legal statements governing interrelations between the concepts. Various legal areas (accounting, fiscality, international law, patent law, etc.) benefit of the assistance of software to help various actors in dealing with daily tasks and decision taking. Similar examples for other domains exist for regulations (and regulatory documents) imposed by regulatory bodies, standards, policies and rules used by private or public entities. More generally, legal is here to be understood as an area which can be modelized with rules or statements which should not be violated by the software application, or at the very least, the software application should indicate to a user when and if a violation of a legal assertion has been made.

The complexity and the rapid evolution of both legal rules and the software system implementing internal business procedures are such that it is cumbersome to check the compliance of a software to the legal regulations and especially if the links between the models are not monitored.

An appropriate mapping of the similarities or dissimilarities between the models is thus needed. An example of mapping between models is disclosed in prior art document WO 2018/033286 A1. This system detects a modification in a model and identifies whether this modification requires other models to be updated accordingly. When a concept of a model is modified, it is assumed that only its siblings are affected by this change and based on this assumption, the models are updated when and if needed.

This system fails however to provide the means to identify the compliance of one model to another model, while building one of the models. There is also room for improvement in the efficiency of the mapping and in the efficiency of the identification of similarities or dissimilarities.

### SUMMARY

It is an objective of the present invention to provide a method to identify similarities or dissimilarities between two models in a more efficient way. By “efficient” is meant here the amount of memory that is necessary and/or the time and energy spent by the computer to solve the required tasks.

The invention is directed to the method as described below such at that exemplarily set forth in claim 1, wherein the dependent claims define various exemplary embodiments of the invention.

The invention also relates to a computer device and a computer program product for carrying out the method of the invention, according to various embodiments as exemplarily set forth in claims 6 and 7.

The invention is particularly interesting in that the reliability and the efficiency of the mapping is enhanced through the different mapping approaches which are combined in a particular sequence.

The invention supports the regulatory-compliance of software. The mapping creation between elements of the models is automated and the compliance checking process is optimized, during coding, during design phases, etc.

The invention allows not only to detect the presence or absence of dissimilarities, it can also specify where the dissimilarities are present, and how to correct these dissimilarities.

The skilled person would recognize that the use of these procedures is manifold:
informing the user of the created mapping relationships;
informing the user of changes in the mapping relationships and signalling the element that is the origin of such a change;
proposing the user with corrections when dissimilarities are detected;
informing of elements that could not be mapped.

### DRAWINGS

FIG. 1 shows schematically the known method of mapping.

FIGS. 2 to 6 exemplarily illustrate various aspects of the invention, in accordance with various embodiments of the invention.

### DETAILED DESCRIPTION

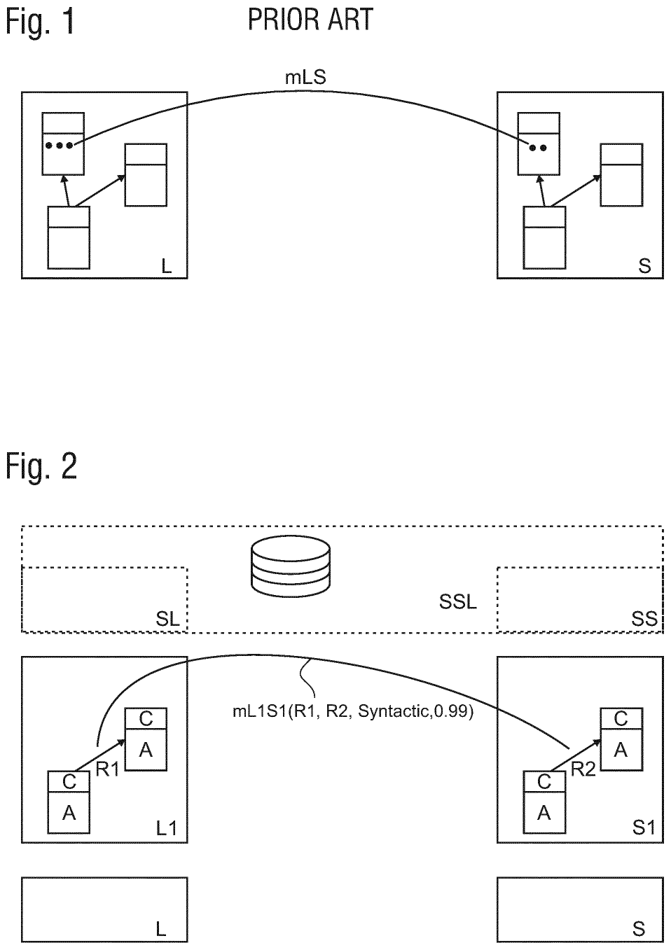

FIG. 1 shows schematically a mapping between two models. A first model L is shown with UML representation. Purely as example, L can be a General Data Protection Regulation model (GDPR in EU). A second model, S, can be a software model (accountability, client database, etc.).

For instance, a “Person” in the GDPR model L can be mapped with the Java Class “Client” in the software model S due to the presence of similarity of attributes “name” and “address” present in both “Person” and “Client”. A mapping relationship is drawn as mLS, i.e. mapping an element of model L to an element of model S.

Currently, some of the similarity relationships can be discovered with different exclusively alternative techniques, for instance:
semantic analysis techniques (e.g. comparing concepts, entities, taxonomies, ontologies, . . . ); or with
syntactic or structural analysis techniques (e.g. a Java class name is similar to the name of a GDPR concept in the GDPR model; the composition/decomposition of Java classes into sub-classes compared to the composition/decomposition of ontology concepts in the GDPR model; by analysing “methods” signatures of those Java classes and properties found in the triples representation of the ontological model of the GDPR); or with
instance data, such as the tax rates in a tax regulation and the tax rates defined in a Java class named “Bill”.

The present invention consists in the simultaneous combination of two or more of these techniques which are only known so far to be applied alone. Technical difficulties are overcome to combine these techniques, as for instance, the merging of conditions and inferences or the input/output to be used for combining one technique with another of these techniques. When one of the techniques combines its input with another one, then the sum of effects of the two techniques goes beyond the cumulated efficiency and reliability of each technique considered alone. This offers a synergistic effect that goes beyond the simple juxtaposition of known techniques.

### Definitions

For the purpose of the illustrated exemplary embodiments, a first model is defined, which can be a legal model, or in other words a data structure that contains data related to a legal matter. “Legal” is to be understood widely, such as regulation, contract, any kind of law (civil, penal, administrative, fiscal, patents, . . . ), any kind of regulations (and regulatory documents, such as safety or financial regulations) imposed by regulatory bodies, standards, policies and rules used by private or public entities. The first model can alternatively be a compliance model, a policy model, or any other model that may lead to negative consequences on health, accountability, engine functioning, vehicles, machines, private life or computer safety, if it is not properly mapped with the software model it relates to.

A second model is related to the first model. Generally, the second model is an application-based or a software-based model aiming at ensuring that the first model does not comprise any defect or ensuring a real-life application of the first model, most often automated with software applications.

Each model comprises elements. The word “elements” is used here to depict any kind of element building the model, such as objects, links, nodes, classes, attributes, activities, flows, simple elements or elements composed of several entities, etc. Those elements are commonly used during the software engineering development process and during the deployment and operation of the software applications. A model is compliant to another model when there isn't any contradiction between corresponding elements. The models can be UML or similar.

The first and/or second model can be related to a respective or to a common support model.

A database containing the rules to apply for the comparison of elements of the models is pre-determined.

Several other related databases can be provided, such as a mapping database recording the mapping of elements, a general database comprising all elements of all models, etc.

The rules predefined in the database of rules are static and specific to the field of the model (healthcare, finances, . . . ). The rules can be for example “if . . . then” rules. Any other kind of rules can be used as known in software engineering, artificial intelligence, rule-based programming, logic programming, production rule system, business rules engine, semantic web and ontologies. One can use simple decision trees or complex belief networks computed with deep-learning algorithms. In all case, a set of rules can be applied at once (“firing” rules) and some of those rules combines two or more of the comparison techniques. When firing rules are applied and executed, they modify data in the databases. Optionally, another cycle can be performed with new firing rules, depending on a stopping criterion (simple counter, resource limit, reliability of results, or any other kind of stopping criteria).

There are three comparative techniques that the rules can use. According to the invention, at least two of these three techniques are combined in one or more firing rules.

The semantic analysis aims at identifying similarities or dissimilarities between elements of different models based on the meaning of the elements (synonyms). Various methods can be used, such as ontologies, taxonomies, conceptual modelling, case-based/frame-based reasoning, natural language programming, etc.

The syntactic and/or structural analysis aims at identifying similarities or dissimilarities between elements of different models based on the way the model is structured or organized, at various scales within the model, identifying common terms or constructs. In this context, information retrieval, java classes analysis, string distance (e.g. Levenstein), etc., can be used.

The data-based analysis aims at identifying similarities or dissimilarities between elements of different models based on the values or instances of the elements. This analysis can use mathematics or statistical analysis, machine learning, clustering, data analytics, etc.

The three techniques of analysis are combined such that one of the techniques provides an output that enriches the input of another one of the techniques within a single rule, or vice versa.

As explained below, the indication of a similarity or dissimilarity is constituted by a three-coordinate vector: <<semantic, syntactic, data-based>>, or by using the result of applying and aggregation function using this three-coordinate vector.

### Description of an Exemplary Embodiment

The following describes an exemplary and not limiting embodiment of the invention, the invention being only limited by the appended claims. Unless stated otherwise, features described for a specific embodiment are applicable to, and can be combined with the features of any other embodiments according to the invention. Also, the detailed discussion focuses here on one iteration of a process that can be iterated several times until a criterion is reached (confidence index, number of iterations, suppression of all dissimilarities, reaching a fixed point (saturation), etc.). The results of one iteration can be used to facilitate the performance of the next iteration.

As shown on FIG. 2, two (base) models L and S are to be mapped. A respective UML model L1 and S1 specifies a conceptualization of a domain in terms of concepts, attributes and relationships. Formally, a model L1, S1 consists of a set of concepts C interrelated by relationships R and having respective attributes A (e.g., label, definition, synonym . . . ). An element e of a model can be any of C, R or A. Each concept has a unique identifier. Furthermore, each attribute is defined for a particular objective, e.g., “label” for denoting concept names or “definition” for giving the meaning in the context where the concept is used.

Given two elements eL1 and eS1 in two different models, a mapping mL1S1 can be defined as

mL1S1=(eL1,eS1,simType, conf)

simType is the type of similarity that exists between eL1 and eS1 and which can be, among others: unmappable [−L], equivalent [≡], narrow-to-broad [<], broad-to-narrow [>] and overlapped [«]. For example, elements can be equivalent concepts (e.g., “head”=“head”), one concept can be less or more general than the other (e.g., “thumb”<“finger”). The type of similarity can also be “semantic similarity”, “syntactic similarity” or “data-based similarity”. Since several analyses are combined, the simType can be a vector composed of three different data/information such as <<semantic, syntactic and/or structural, data-based>>.

“conf” is an indicator of the confidence of the relation between eL1 and eS1. The confidence indicator can be used to prioritise the need to correct dissimilarities (ranking). It can be a computed value comprised between 0 and 1. Similarly to the simType, the confidence can be analysis-dependent and presented as a vector <<confSemantic, confSyntactic, confData-based>>.

A relationship mL1S1 is illustrated on FIG. 2, between R1 and R2, two relations between entities of the models L1 and S1.

To help establishing these relationships, a support model SL can be set that is a reference model that contains for example taxonomies that are true for several L models. Similarly, a support model SS for models of the kind S can be set. Alternatively or complementarily, a common support model SSL for reference of both models L and S can be set.

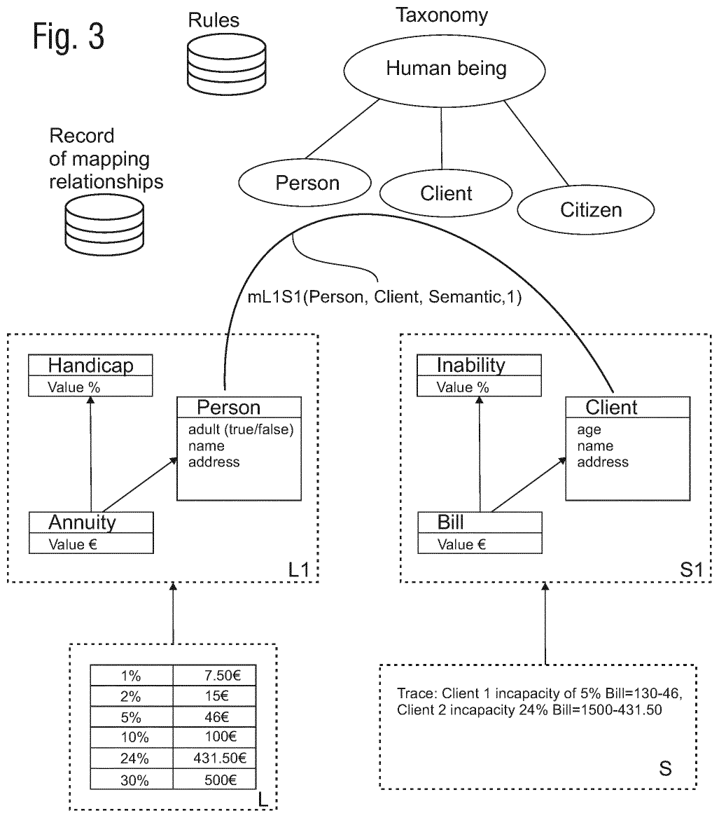

FIG. 3 illustrates the semantic analysis to establish a relationship between elements of the two models. This can constitute a first step in the detection of similarities or dissimilarities.

In this example, the legal model L contains articles of law. Purely as an example, an article can read “The insured person having a certain % of handicap should receive a certain annuity (€)”.

The support model SSL (ontology of the field) contains a taxonomy of whom “human being” may be: a person, a client, a citizen, an employee, an intern, a person under multilateral agreement, etc.

The software model S contains code and is aimed for instance at an insurance payment service.

Both models L, S can be formalized with a UML model L1, S1.

By semantic analysis of the two models L1 and S1, based on the support model SSL, the relationship can be established between the “client” variable of the code and the “insured person” of the law. A database can record this relationship. In that case, the rule used to govern the semantic analysis is of the kind: IF two respective elements of the two models L1, S1 have a mapping with a common semantic element of their support model SSL, THEN these two respective elements are semantically mapped. Optionally, a database can record this mapping as “Client isA Person”.

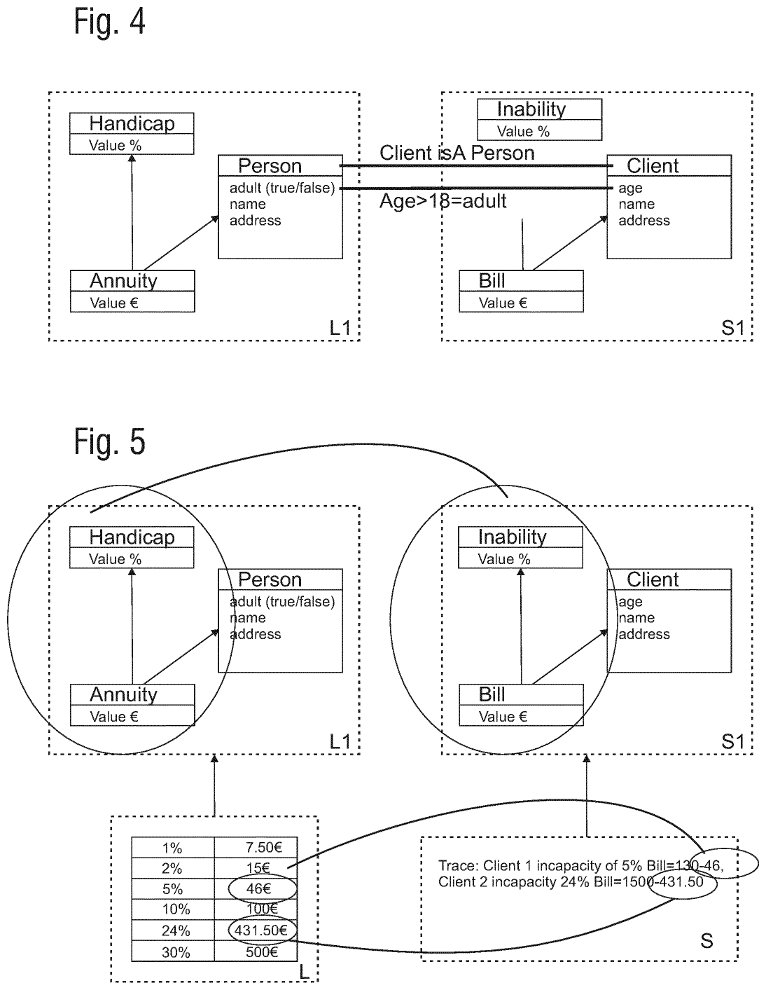

In a second step shown on FIG. 4, the semantic and syntactic analysis are combined in one rule. The structure (attributes) of the classes “Client” and “Person” are compared. The rule applied here can be as follows: IF two UML classes are semantically linked, AND IF they have at least one syntactically neighbouring attribute (for example identified by means of string distance), THEN the attributes are semantically related and are also semantically related to their UML class.

A semantical relationship can thus be generated between the two attributes of the two respective models.

In the example of FIG. 4, the two attributes “name” and “address” are thus related.

In a third step still shown on FIG. 4, the semantic and syntactic analysis can again be combined in one rule to establish a relationship between “age≥18” and “adult=true”. The rule that can be applied here can be of the type: IF two UML classes have a semantic relationship AND have an attribute that is semantically related (this can be inherited from the support model that contains information of equivalence between “age≥18” and “adult=true”), THEN the attributes are semantically related and are also related to their class. A mapping between attribute “age” and attribute “adult” is made. The database recording the relationship is also complemented with “age≥18”⇔“adult=true”.

In a fourth step, the data-based analysis can be made on the basis of already set relationships. The rule applied can be: IF mathematically equivalent elements are found (for example similar type, value, etc. found through data analytics), THEN a mapping relationship is created between these elements.

In the example given, the legal model contains a table that relates the % of handicap to values in euros. There are also pairs of values which can be retrieved in the software model. Thus, the elements of the table and the values of the code are recognized as related.

In a fifth step also shown on FIG. 5, the data-based analysis is combined in one rule with the semantic analysis and the syntactic analysis. The rule can be of the form: IF elements have been identified as data equivalent (similar to step four above) AND are also semantically related, THEN create a syntactic relationship between the elements.

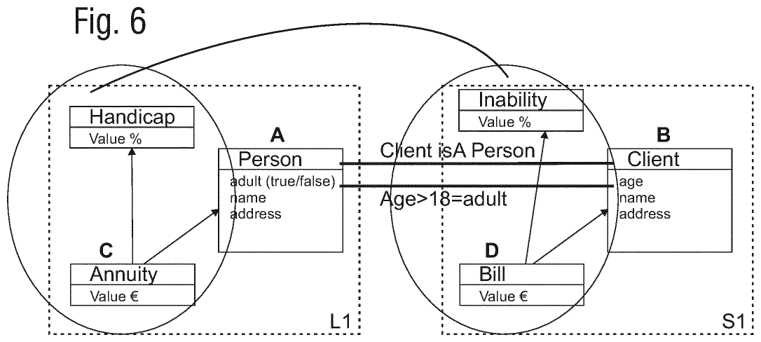

A sixth step can be carried out as illustrated on FIG. 6, with the combined rule: IF two UML classes A and B of two models are semantically related AND they build a structural link with respective classes C and D (A linked to C in one model, B linked to D in the other model), AND IF C and D are syntactically related (for instance as established in step 5), THEN C and D are semantically related AND the semantic link between C and D is a link of equivalence.

It is to be noted that none of the steps is as such essential to the invention which should at least comprise one rule that combines two of the different techniques to enhance the confidence of the establishment of the relationships.

Each of the steps explained above can be performed independently from, sequentially with, or simultaneously with, any other step.

Also, the rule used for each step mentioned above is only an example of one rule that can be used. The rules can be updated and adapted to the particulars of the models to be compared. When several iterations are done, the rules can evolve with the number of iterations.

For example, the rules can be adapted after some iterations when the confidence of the relationships exceeds a threshold (for instance, when confidence is greater than <0.7; 0.5; 0.4>). Depending on the nature of the concepts that are manipulated («privacy», «business» . . . ), the threshold of confidence can be higher or lower. Thus, the rules can auto-adapt to the concepts that they manipulate.

For instance, when there is a data-based similarity of the kind “data-based” between two concepts, then, the threshold of the syntactic string-distance analysis can be lowered for those concepts during the next iterations. Similarly, instead of modifying the threshold of the syntactic analysis, one can modify the ontology used for the semantic analysis of those concepts.

The method used herein is particularly versatile as it can use a combination of complex rules involving many techniques of analyses and more simple rules.

Furthermore, in the given examples, mapping relationships are only added into the database recording the relationships. Similar procedure can be done to delete or update these relationships.

1.-7. (canceled)

8. A method for the identification of similarities and dissimilarities of mappings between elements of a first model and elements of a second model, an element being one of: an object, a link, a node, a class, an attribute, an activity, or a flow, wherein the method uses a processor for performing a model mining of the elements of both models in accordance with pre-defined rules, at least one of the pre-defined rules involving at least two of the following analyses:
a semantic analysis of the elements;
a syntactic of the elements;
a structural analysis of the elements; and
a data-based analysis of the elements;
and wherein based on these analyses, similarities and dissimilarities mappings between the elements of the first model and the second model are identified and are provided to a user.

9. The method according to claim 8, wherein upon a change of a similarity into a dissimilarity mapping, the method comprises a step of prompting the user with at least one suggestion of a modification of one of the models to restore the similarity.

10. The method according to claim 8, wherein the step of model mining is performed further on a support model of the first model, a support model of the second model, and/or a support model that is common to both the first and the second model.

11. The method according to claim 8, wherein one of the models is a computer-implemented model of a legal model related to at least one of: law, regulations or regulatory documents imposed by regulatory bodies, standards, policies, public rules or private rules.

12. The method according to claim 8, wherein one of the models is a software model, representing the data structure, the control flow, or the network structure of a software.

13. The method according to claim 8, wherein the identification of similarities and dissimilarities mappings between the elements of the first model and the second model is made based on said at least two analyses and also based on pre-performed mappings.

14. A computing device comprising a memory element and a processor, wherein the processor has read and write access to at least one database comprising data of a legal model and of a software model, wherein each model is organized with a data structure, wherein the processor is further configured for performing a method for the identification of similarities and dissimilarities of mappings between the elements of the legal model and the elements of the software model, an element being one of: an object, a link, a node, a class, an attribute, an activity, or a flow, wherein the method uses the processor for performing a model mining of the elements of both models in accordance with pre-defined rules, at least one of the pre-defined rules involving at least two of the following analyses: a semantic analysis of the elements; a syntactic analysis of the elements, a structural analysis of the elements; and a data-based analysis of the elements; and wherein based on these analyses, similarities and dissimilarities mappings between the elements of the legal model and the software model are identified and are provided to a user.

15. A computer program product comprising a computer-readable medium on which a computer program is stored, wherein the program, when run on a computer, causes the computer to carry out a method for the identification of similarities and dissimilarities of mappings between the elements of a first model and the elements of a second model, an element being one of: an object, a link, a node, a class, an attribute, an activity, or a flow, wherein the method uses a processor of the computer for performing a model mining of the elements of both models in accordance with pre-defined rules, at least one of the pre-defined rules involving at least two of the following analyses: a semantic analysis of the elements; a syntactic analysis of the elements, a structural analysis of the elements; and a data-based analysis of the elements; and wherein based on these analyses, similarities and dissimilarities mappings between the elements of the first model and the second model are identified and are provided to a user.
